(19) United States
(12) Patent Application Publication
(10) Pub. No.: US 2019/0376649 A1
(43) Pub. Date: Dec. 12, 2019

(54) A GAS CYLINDER MONITORING DEVICE

(71) Applicant: LINDE AKTIENGESELLSCHAFT, Munich (DE)

(72) Inventors: Rigoberto PEREZ DE ALEJO, London, Surrey (GB); Dennis REID, London, West Sussex (GB)

(73) Assignee: LINDE AKTIENGESELLSCHAFT, Munich (DE)

(21) Appl. No.: 16/472,327

(22) PCT Filed: Dec. 8, 2017
(86) PCT No.: PCT/EP2017/081992

§ 371 Date: Jun. 21, 2019

(30) Foreign Application Priority Data
Dec. 23, 2016 (GB) 1622194.7

(51) Int. Cl. F17C 13/02; F17C 13/04; G01F 1/684

(52) U.S. Cl. CPC F17C 13/026; F17C 13/04; G01F 1/6842; F17C 2250/0439; F17C 2250/0636; F17C 2221/011; F17C 2270/02; F17C 2250/034; F17C 2250/0426; F17C 2250/043; F17C 2250/0491; F17C 2250/0495; F17C 2260/017; F17C 2250/032

(57) ABSTRACT

A gas cylinder monitoring device (34) for use with a valve (18) for controlling the flow of gas from a cylinder (14). The valve (18) has a valve body (20), and the device comprises an ambient temperature sensor (38) to measure the ambient temperature (TA), a valve body temperature sensor (36) to measure the temperature (TV) of the valve body, and a processor (42). The processor (42) operates to process a compensated temperature (CT) calculated from the difference between the measured valve body temperature (TV) and the ambient temperature (TA) over time (t). A flow-rate (FR) of the flow of gas from the cylinder and/or the pressure (P) on the gas is determined.

The present invention relates to a gas cylinder monitoring device, in particular to a gas cylinder monitoring device for use with gas cylinders for supplying clinical gasses such as, for example, oxygen, argon, nitrous oxide, xenon, nitric oxide, helium and mixtures thereof to patients, and for supplying industrial gases such as oxygen, nitrogen, carbon dioxide and argon and mixtures thereof.

Known gas cylinders include analogue valves to control the flow of gas from the cylinder. The valve typically includes a mechanical pressure gauge to display the pressure of the gas in the cylinder. It is important, particularly when supplying clinical gases, that the cylinder does not run out of gas. Whilst the pressure gauge displays the pressure of gas remaining, human intervention is required in order to retrieve the information, and some users find it difficult to interpret the information supplied and make incorrect determinations of important data such as the total time of gas supply remaining.

In an attempt to overcome the above problem, analogue valves have been replaced by so-called intelligent valves which incorporate an electronic monitoring system to process the gas pressure to determine information which is more pertinent, for example, the time remaining before the gas in the cylinder either runs out or reaches a pre-determined threshold. The electronic monitoring system can also wirelessly transmit the gas pressure to a remote computer which includes a management system which not only enables analysis of the gas pressure, but can identify gas cylinders which require replacing due to having low gas content. Hospitals will typically have many gas cylinders at different locations, and therefore it is beneficial to be able to manage the contents of those gas cylinders via a remote computer.

Whilst the use of intelligent valves eliminates the need for human intervention to check the gas contents, and enables remote management, the majority of gas cylinders used in hospitals still employ analogue valves.

The managing of the gas contents of cylinders in hospitals which use cylinders with analogue valves and intelligent valves is a particular problem because it is only the cylinders with intelligent valves that can communicate with and be managed by the remote computer, leaving those cylinders with analogue valves at greater risk of running out of gas.

Whilst it would be possible to identify cylinders with analogue valves and replace them with intelligent valves, this is not always practical, and can be prohibited by cost.

It would be desirable to be able to better manage the contents of gas cylinders with analogue valves.

Thus, according to the present invention there is provided a gas cylinder monitoring device for use with a valve for controlling the flow of gas from a cylinder, the valve having a valve body, the device comprising an ambient temperature sensor to measure the ambient temperature, a valve body temperature sensor to measure the temperature of the valve body, and a processor operable to process a compensated temperature calculated from the difference between the measured valve body temperature and the ambient temperature over time to determine the flow-rate of the flow of gas from the cylinder and/or the pressure on the gas.

When a gas experiences a rapid change in pressure, for example when it flows through a valve or regulator, the gas experiences a temperature change in accordance with the First Law of Thermodynamics. This is an iso-enthalpic process and is known as the Joule-Thomson effect. This effect can be exploited when a gas flows from a cylinder and through a valve body by monitoring and processing the valve body temperature change when the gas flows through. The valve body temperature can processed to distinguish between the change in temperature that is attributable to the flow-rate of the gas, and the change in temperature due to the pressure change in the cylinder. The flow-rate of the gas and the pressure change in the cylinder can then both be determined from the temperature and time data. From the flow-rate it is possible to calculate the change in volume in the gas cylinder over the time the valve was opened, and from the pressure change it is possible to calculate the volume change based on knowing the initial or last recorded and stored pressure and volume. Knowing the volume change enables the remaining volume of gas to be calculated.

The measured compensated temperature and time information can be processed to calculate the rate of change of temperature with time (the first temperature derivative), and the rate of change of the first derivative with time (the second temperature derivative) at any given time. Advantageously, information about the gas cylinder contents can be obtained from measuring the temperature alone, with having to rely on flow-rate or pressure data which requires more sophisticated and invasive monitoring equipment.

Preferably, the flow-rate is determined by comparing the amplitude of the peak second derivative of the compensated temperature after the valve has opened with valve calibration data. The valve calibration data enables a relationship between the flow-rate and the amplitude of the peak second derivative of the compensated temperature to be established, which can then be used to determine the actual flow-rate when the valve is in operation. Alternatively, the flow-rate is determined by comparing the amplitude of the peak first derivative of the compensated temperature after the valve has opened with valve calibration data.

Preferably, the pressure is determined by comparing the amplitude of the difference between the peak second derivative of compensated temperature after the valve has opened and the peak second derivative of compensated temperature when the valve closes, with valve calibration data. The valve calibration data enables a relationship between the pressure and the amplitude of the difference between the peak second derivative of compensated temperature after the valve has opened and the peak second derivative of compensated temperature when the valve closes to be established, which can then be used to determine the actual pressure when the valve is in operation. Alternatively, the amplitude of the difference between the peak first derivative of compensated temperature after the valve has opened and the peak first derivative of compensated temperature when the valve closes can be compared with valve calibration data to determine the pressure.

Insofar as it relates to flow-rate, the valve calibration data is established for a particular valve type by measuring the compensated temperature over time, and recording the amplitude of the peak second compensated temperature derivative for different flow-rates.

Insofar as it relates to pressure, the valve calibration data is established for a particular valve type by measuring the compensated temperature over time, and the pressure over time for a fixed flow-rate, and recording the difference between the peak second derivative of compensated temperature after the valve has opened and the peak second derivative of compensated temperature when the valve closes for different pressures.

By repeating the calibration exercise for valves with different characteristics, such as size and material type, it is possible to select the appropriate calibration data, and therefore relationship between the temperature data and flow-rate and pressure, according to that valve when the monitoring device is used with that valve.

Calibration data will also need to be established for different cylinder properties and initial filling pressures.

It is important to identify when the valve opens and closes so that the correct temperature data can be used. In one embodiment, the processor determines the valve is open at the time when the change in compensated temperature is above a threshold, for example, 1° C. Alternatively, the processor can determine the valve has opened when the first temperature derivative is a negative value, i.e. the temperature has decreased. In one embodiment, the processor can determine the valve is closed when the first derivate of the compensated temperature becomes positive and/or reaches a steady state.

Preferably the monitoring device is releasably attachable to the valve body of the gas cylinder enabling it to be used with different gas cylinders.

The gas cylinder monitoring device can include a wireless transmitter which is operable to transmit data associated with the gas cylinder to a remote computer to enable management of the gas cylinder contents.

The data transmission can be from the monitoring device directly to the remote computer, or via one or more hubs which are themselves connected to the remote computer. Longer distance transmission, i.e. that from the monitoring device to the remote computer will use Wi-Fi®, whereas shorter distance transmission from the device to the hubs is more suited to using Bluetooth® transmission. The inclusion of a wireless transmitter in the device has the advantage that analogue valves incorporating the device, and intelligent valves, both of which will typically be present in a hospital, can both communicate, and be managed by the central computer.

The data can include time and temperature data associated with operation of the valve, as well as data to identify the type and location of the gas cylinder to which the monitoring device is as attached.

According to another aspect of the present invention there is provided method of determining the flow-rate of a gas from a cylinder and/or the pressure of the gas comprising the steps of measuring the ambient temperature, measuring the valve body temperature, processing the difference between the ambient and valve body temperature over time to determine the flow-rate of the flow of gas from the cylinder and/or the pressure on the gas.

The invention will now be described by way of example only with reference to the accompany drawings, in which:

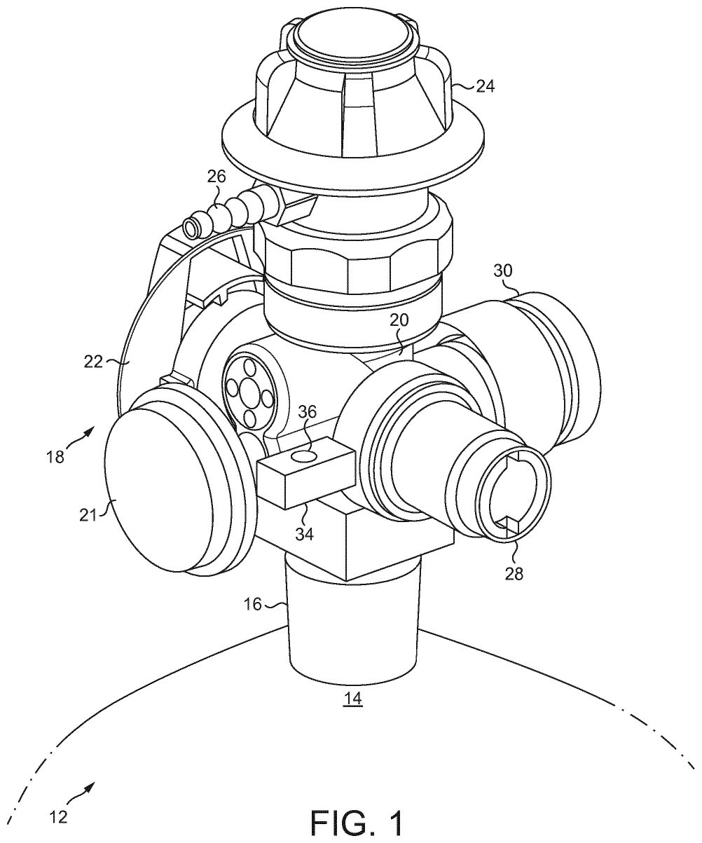

FIG. 1 is a perspective view of an analogue valve including a gas monitoring device according to one embodiment of the present invention,

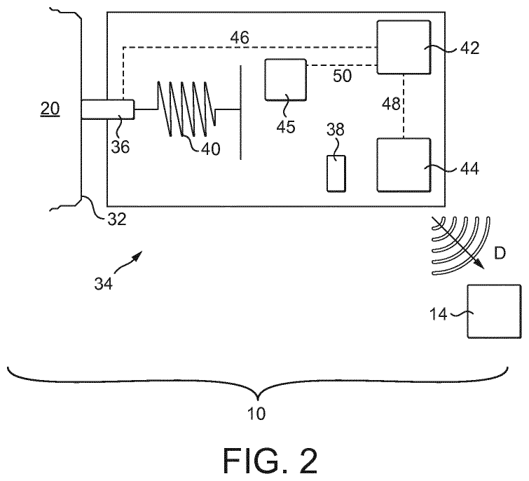

FIG. 2 is a schematic view of the gas monitoring device of FIG. 1, and

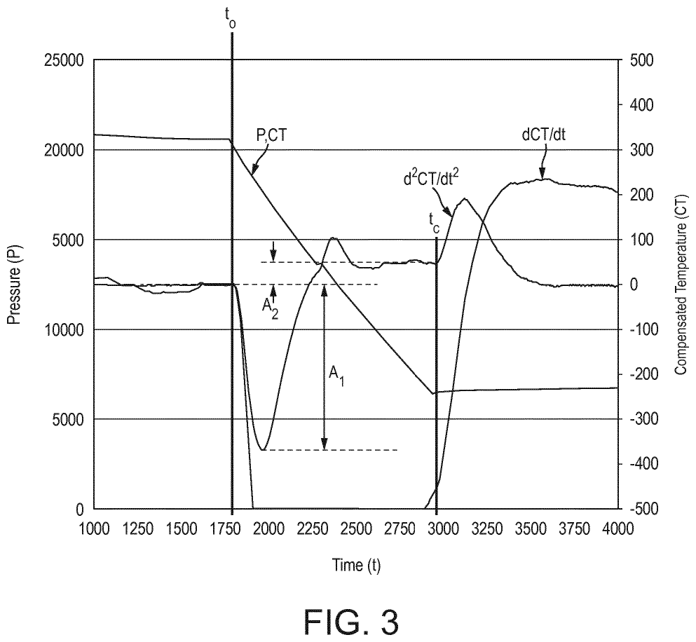

FIG. 3 is a graph showing how compensated temperature of the valve of FIG. 1 varies with time.

In FIGS. 1 and 2, there is shown a gas cylinder monitoring system 10 comprising a gas cylinder assembly 12, a gas cylinder monitoring device 34 and a remote computer 14.

The gas cylinder assembly 12 comprises a conventional gas cylinder 14 (only part of which is shown) which is mechanically and fluidly connected via connector 16 to a conventional analogue valve assembly 18. In this embodiment, the cylinder is filled with oxygen.

The valve assembly 18 comprises a valve body 20 which has a primary on-off valve 22, a flow-regulator valve 24, and an outlet connection 26. The valve assembly 18 also has a mechanical pressure gauge 21 to indicate the pressure in the gas cylinder 14, a filling port 30, and a medical quick connector 28. The valve body 20 has an external surface 32.

The gas cylinder monitoring device 34 has a valve body temperature sensor in the form of a thermistor 36 to measure the valve body temperature TV, and an ambient temperature sensor 38 to measure the ambient temperature TA. The thermistor 36 is mechanically biased via spring 40 such that when the device is assembled onto the valve body 20 as will be described below, the thermistor 36 engages with the outer surface 32.

The gas cylinder monitoring device 34 includes a fixing means (not shown) to enable it to be releasable attachable to the valve body 20. Any suitable fixing means is envisaged such as a strap or a clamp, the requirement for the fixing means being that the thermistor 36 engages with the outer surface 32 when the device 34 is attached to the valve body 20.

The gas cylinder monitoring device 10 also includes an internal processor 42 and a Wi-Fi® transmitter 44. The temperature sensors 36,38 are connected to the processor 42 via wires 46,50, and the internal processor 42 is connected to the Wi-Fi® transmitter 44 via wire 48.

The gas cylinder monitoring device 10 includes a battery 45 to power the processor 42 and the transmitter 44.

The internal processor 42 can store reference data associated with the gas cylinder 14 to which it is attached. The reference data includes valve calibration data which equates temperature change of the valve body to both gas flow-rate FR through the valve body 20 and the pressure P when the flow-regulator valve 24 is opened.

The valve calibration data is specific and selected according to the valve 18 and cylinder 14 to which the valve is attached, and include valve material, valve size, filling pressure of the cylinder 14, cylinder volume, and cylinder material.

The processor 42 is also operable to calculate a compensated temperature TC over time, the compensated temperature TC being the difference between the valve body temperature TV and the ambient temperature TA, and then determine the first temperature derivate (dCT/Dt) and the second temperature derivate (d²CT/dt²). The compensated temperature TC data, and the first and second temperature derivative data can be used during operation of the valve to determine the flow-rate and pressure change in the cylinder as will be described below.

From the determined flow-rates and pressure changes, the volume change in the cylinder, and hence the remaining volume, can be calculated as will be described below.

The transmitter 44 can transmit data, including the cylinder details and the remaining volume left in the cylinder 14 to the remote central computer 14 to make the operator (not shown) of the central computer 14 aware if the cylinder needs changing.

The central computer 14 and/or the processor 42 can include a visible and/or audible alarm to indicate when the contents of the gas cylinder reach a pre-determined lower threshold.

In the above embodiment, the processor 42 in the device 34 processes the temperature and time data and calculates the remaining gas content remaining and sends that information to the central computer 14. In an alternative embodiment, the temperature and time data can be sent directly to, and processed by, the central computer, i.e. there is no need for any processing to be done in the monitoring device.

The temperature data, or the time or gas content remaining is sent via Wi-Fi® directly to the central computer 14 in the above embodiments. Alternatively, the device can transmit the data using Bluetooth® to hubs (not shown) positioned in key locations such as the ward, surgery, filling station, storage station and transportation when the device is within range of those hubs. The hubs can then communicate with the central computer using wireless transmission protocols more suitable for longer distances, such as Wi-Fi®.

The monitoring system 10 operates as follows:

Firstly, valve calibration data is created for each of the different valve types, cylinder types, and initial filling pressure, and stored in the processor 42 as follows:

The device 34 is attached to the valve 18 such that the thermistor 36 engages with the valve body 20.

For calibration purposes, the actual pressure and flow-rate data is required. This could be achieved by using an intelligent valve which can measure the pressure and flow-rate to high degrees of accuracy.

The valve calibration data is established for different flow-rates by measuring the compensated temperature over time. The amplitude of the peak second compensated temperature derivative is calculated for each of the different flow-rates, and a relationship between that amplitude and the actual flow-rate is established so that when the valve is in normal operation, an estimated flow-rate can be determined from the processed time and temperature data without the need for actual flow-rate data.

The valve calibration data is established for different pressures by measuring the compensated temperature and the actual pressure over time for a fixed flow-rate. The amplitude of the difference between the peak second derivative of compensated temperature after the valve has opened and the peak second derivative of compensated temperature when the valve closes is calculated for different pressures, and a relationship between that amplitude and the actual pressure is established so that when the valve is in operation, an estimated pressure can be determined from the processed time and temperature data without the need for actual pressure data.

The valve calibration data is stored on the device and selectable via a button (not shown) or via instruction from the central computer according to the valve type upon which the device is mounted.

In the calibration method described above, the amplitude of the second temperature derivative is used to equate temperature data to flow-rate and pressure. Alternatively, or additionally, the amplitude of the first temperature derivative can be used to establish a relationship between that amplitude and the actual flow-rate and pressure.

Once the device has been calibrated, it is used with the gas cylinder as follows:

The correct valve calibration data is selected according to the valve type.

The flow-regulator valve 24 is opened for a period of time, and the compensated temperature TC is recorded during the operation of the valve.

The processor 42 processes the compensated temperature TC and determines the amplitude A₁ of the peak second compensated temperature derivative after the valve 18 has opened at time tₒ. The processor 42 establishes the valve has opened when the compensated temperature CT change is above 1° C.

The processor 42 processes the compensated temperature TC and determines the amplitude A₂ of the difference between the peak second derivative of compensated temperature CT after the valve 18 has opened and the peak second derivative of compensated temperature when the valve 18 closes at time t_{c}. The processor 42 establishes the valve 18 is closed when the first derivative of the compensated temperature becomes positive.

The flow-rate FR is calculated by comparing the determined amplitude A₁ with the calibration data which has established the relationship between amplitude and flow-rate.

The pressure P is calculated by comparing the determined amplitude A₂ with the calibration data which has established the relationship between amplitude and pressure.

From the determined flow-rate, a corresponding volume change can be calculated based on the time the valve was open.

From the determined pressure, a corresponding volume change can be calculated based on the initial or previous pressure and volume, both of which are known. Accumulative pressure and volume changes are stored in the processor 42 for subsequent pressure and volume calculations.

Once the volume changes have been calculated, the volume remaining in the cylinder can be determined based on the previous volume, and transmitted to the central computer 14.

The processor 42 can optionally compare the difference between the change in volume determined from the determined flow-rate (FR) and the change in volume determined from the determined pressure (P), and compares that difference with a pre-determined difference threshold percentage, for example, 10% to give an indication of the accuracy of the determined change in volumes.

If the calculated volume remaining in the cylinder is below a pre-determined threshold then an alarm can be activated either on the device itself, or on the central computer.

In the above embodiment, the processor establishes the valve has opened when the compensated temperature CT change is above 1° C. and establishes the valve is closed when the first derivative of the compensated temperature becomes positive. In an alternative embodiment, the processor can determine the valve is open from the first and/or second temperature derivative, and closed when the first compensated temperature derivative is positive and/or reaches a steady state. It will also be appreciated that the Joules-Thompson coefficient is dependent on the type of gas used, for example in the above embodiment where the gas is oxygen, the temperature change is negative when gas flows through the valve. Other gases will experience a positive temperature change.

In the above embodiments, it will be appreciated that there will be background noise which can impact on the time and temperature data. This noise can be removed by including a filter in the processor. Suitable filters include low band pass filters or finite impulse response (FIR) filters, the choice of filter depending on the performance characteristics of the processor.

It will be understood that the device of the present invention enables information about the contents of the gas cylinder to be obtained in real-time by monitoring and processing the ambient and valve body temperatures. More specifically, the estimated flow-rate and pressure is obtained by processing the time and temperature data to calculate the first and second temperatures derivatives, and then comparing the amplitudes of the second temperature derivatives when the valve opens and closes with valve calibration data. Alternatively, or additionally, the first temperature derivative data can be used to identify valve opening and closing by detecting changes in the flow-rate. From that estimated flow-rate and pressure it is possible to calculate the volume change and hence the volume remaining in the cylinder. The device of the present invention can also be used to detect when the cylinder has been filled due to the resulting temperature change experienced when the pressure in the cylinder increases from zero bar to two or three hundred bar.

It will also be understood that the device can be easily retrofitted to conventional analogue valves without the need to interfere with the high pressure components of the gas cylinder.

By retrofitting, the device enables analogue valves to operate in a similar way to intelligent valves, by firstly displaying more pertinent cylinder data such as remaining volume, and also by being able to communicate with a central computer for easier management of gas contents, particularly when both retrofitted analogue valves and intelligent valves are used in the same location.

1. A gas cylinder monitoring device (34) for use with a valve (18) for controlling the flow of gas from a cylinder (14), the valve (18) having a valve body (20), the device comprising an ambient temperature sensor (38) to measure the ambient temperature (TA), a valve body temperature sensor (36) to measure the temperature (TV) of the valve body, and a processor (42) operable to process a compensated temperature (CT) calculated from the difference between the measured valve body temperature (TV) and the ambient temperature (TA) over time (t) to determine the flow-rate (FR) of the flow of gas from the cylinder and/or the pressure (P) on the gas.

2. A gas cylinder monitoring device according to claim 1 in which the flow-rate (FR) is determined from the amplitude (A₁) of the peak second derivative of the compensated temperature (CT) after the valve (18) has opened.

3. A gas cylinder monitoring system according to claim 2 in which the flow-rate (FR) is determined by comparing the amplitude (A₁) of the peak second derivative of the compensated temperature (CT) with valve calibration data.

4. A gas cylinder monitoring device according to claim 1 in which the pressure (P) is determined from the amplitude (A₂) of the difference between the peak second derivative of compensated temperature (CT) after the valve (18) has opened and the peak second derivative of compensated temperature (CT) when the valve (18) closes.

5. A gas cylinder monitoring device according to claim 4 in which the pressure (P) is determined by comparing the amplitude (A₂) of the difference between the peak second derivative of compensated temperature (CT) after the valve (18) has opened and the peak second derivative of compensated temperature (CT) when the valve (18) closes with valve calibration data.

6. A gas cylinder monitoring device according to claim 3 in which the valve calibration data is established for a particular valve type by measuring the compensated temperature (CT) over time (t) for different flow-rates.

7. A gas cylinder monitoring device according to claim 5 in which the valve calibration data is established for a particular valve type by measuring the compensated temperature (CT) over time (t) and the pressure (P) over time (t) for a fixed flow-rate.

8. A gas cylinder monitoring device according to claim 1 in which the processor (42) determines the valve (18) is open when the change in the compensated temperature (CT) is above a threshold value.

9. A gas cylinder monitoring device according to claim 8 in which the threshold value is 1° C.

10. A gas cylinder monitoring device according to claim 1 in which the processor (42) determines the valve (18) is open from the first and/or second temperature derivative.

11. A gas cylinder monitoring device according to claim 1 in which the processor (42) determines the valve (18) is closed when the first compensated temperature derivative is positive and/or reaches a steady state.

12. A gas cylinder monitoring device according to claim 1 in which the processor (42) determines a change in volume of the gas in the cylinder (14) from the determined flow-rate (FR) and the period of time (t) the valve (18) is open.

13. A gas cylinder monitoring device according to claim 1 in which the processor (42) determines a change in volume of the gas in the cylinder (14) from the difference between the determined pressure (P) when the valve (18) was opened and when the valve (18) was closed.

14. A gas cylinder monitoring device according to claim 13 in which the processor (42) compares the difference between the change in volume determined from the determined flow-rate (FR) and the change in volume determined from the determined pressure (P), and compares that difference with a pre-determined difference threshold.

15. A gas cylinder monitoring device according to claim 1 in which the valve body temperature sensor (36) cooperates with the valve body (20) by engagement with the valve body (20).

16. A gas cylinder monitoring device according to claim 15 further comprising biasing means (40) to bias the valve body temperature sensor (36) into engagement with the valve body (20).

17. A gas cylinder monitoring device according to claim 1 in which the device (34) is releasably attachable to the valve body (20).

18. A gas cylinder monitoring device according to claim 1 further comprising a wireless transmitter (44) operable to transmit data (D) associated with the cylinder (14).

19. A gas cylinder monitoring device according to claim 18 in which the wireless transmitter (44) is operable to be in direct wireless communication with a central computer (14).

20. A gas cylinder monitoring device according to claim 18 in which the transmitter (42) is a Bluetooth® transmitter and is operable to be in direct wireless communication with one or more hubs and the one or more hubs are in wireless communication with a central computer (14).

21. A gas cylinder monitoring device according to claim 1 further comprising a filter operable to remove noise from the compensated temperature data.

22. A gas cylinder monitoring device (34) for use with a valve (18) for controlling the flow of gas from a cylinder (14), the valve (18) having a valve body (20), the device comprising an ambient temperature sensor to measure the ambient temperature (TA), a valve body temperature sensor (36) to measure the temperature (TV) of the valve body (20), and a wireless transmitter (44) operable to transmit data (D) associated with the cylinder (14).

23. A gas cylinder monitoring system (10) comprising a cylinder monitoring device according to claim 22 and a processor (42) operable to process a compensated temperature (CT) calculated from the difference between the measured valve body temperature (TV) and the ambient temperature (TA) over time (t) to determine the flow-rate (FR) of the flow of gas from the cylinder and/or the pressure (P) on the gas.

24. A gas cylinder monitoring system (10) according to claim 23 comprising a central computer (60) in which the processor is part of the central computer.

25. A method of determining the flow-rate (FR) of a gas from a cylinder (14) and/or the pressure (P) of the gas comprising the steps of:
measuring the ambient temperature (TA),
measuring the valve body temperature (TV),
processing the difference between the ambient (TA) and valve body (TV) temperature over time (t) to determine the flow-rate (FR) of the flow of gas from the cylinder (14) and/or the pressure (P) on the gas.
